(19) United States
(12) Patent Application Publication
(10) Pub. No.: US 2011/0074973 A1
(43) Pub. Date: Mar. 31, 2011

(54) CAMERA AND RECORDING METHOD THEREFOR

(76) Inventor: Daisuke HAYASHI, Saitama (JP)

(21) Appl. No.: 12/893,769

(22) Filed: Sep. 29, 2010

(30) Foreign Application Priority Data
Sep. 30, 2009 (JP) 2009-226055

(51) Int. Cl. H04N 5/228

(52) U.S. Cl. 348/222.1; 348/E05.024

(57) ABSTRACT

An image captured with an imaging section is thinned out to generate a low resolution image. A face detection section obtains the low resolution image. The face detection section detects a face image from the low resolution image. A still state detector judges whether the face image is in a still state. The still state detector counts the number of frames which has been judged still by the still state detector. When the number of frames judged still reaches a predetermined value during half-pressing of a release button, a CPU automatically records the low resolution image as a substitute for a still image.

### FIELD OF THE INVENTION

The present invention relates to a camera having a face detection device for detecting a face image in an image, and a recording method therefor.

### BACKGROUND OF THE INVENTION

Recently, an electronic camera adopts a face detection device for detecting a face image from an image being captured. Such electronic camera focuses on the detected face image and sets the exposure settings with respect to the face image to obtain correct exposure.

A camera for identifying an orientation of a face image based on a detection result of a face detection device and capturing an image upon detection of the face image oriented in a predetermined direction is known (see Japanese Patent Laid-Open Publication No. 2001-051338).

An imaging apparatus for automatically capturing still images based on stability judgment of a face detection device is known (see U.S. Patent Application Publication 2008/0187185 corresponding Japanese Patent Laid-Open Publication No. 2008-193411). For the stability judgment, the face detection device judges whether face evaluation values calculated based on image data continuously remain within a predetermined variable range for a predetermined time or the predetermined number of image capture. This imaging apparatus assumes that “the face motion of the subject is small and stable” when the face evaluation values continuously remain within a predetermined variable range for a predetermined time or the predetermined number of image capture, and automatically records still images.

A slight movement of the subject, for example, a blink, at the shutter release causes motion blur in the recorded image. Such motion blur is extremely difficult to prevent because the motion of the subject is unpredictable. The imaging apparatus disclosed in U.S. Patent Application Publication 2008/0187185 automatically records an image when the face of the subject becomes stable. Because the stability judgment has tolerance, an image is recorded even when the subject moves slightly. As a result, the motion blur cannot be prevented. In addition, the imaging apparatus disclosed in U.S. Patent Application Publication 2008/0187185 automatically records the full-pixel image data with high resolution. If the stable condition continues for a long time, the images are successively recorded. As a result, the capacity of a recording medium is exhausted in a short time.

Recently, the cost of the electronic camera tends to increase due to improvement on LSI operation frequency and larger memory bus bandwidth caused by high image quality of an image sensor such as a CCD or a CMOS, high speed shooting, high speed continuous shooting, a large and high image quality screen for displaying a through image (live view image), and the like. The through image for monitoring, displayed on a display section on the back of the camera, is composed of low resolution image data which is generated by thinning out the captured full-pixel image data. However, when full-pixel image data is successively recorded in a camera having the conventional specifications to prevent the cost increase due to the LSI and the like, as disclosed in U.S. patent Application Publication No. 2008/0187185, troubles may occur in displaying the through image because the enormous amount of image data may exceed the capacity of the memory bus bandwidth.

### SUMMARY OF THE INVENTION

A principal object of the present invention is to provide a camera for surely preventing motion blur, and a recording method for this camera.

Another object of the present invention is to prevent inconvenience of exhausting a recording medium or recording device and making the camera incapable of recording, and a recording method for this camera.

Still another object of the present invention is to provide a camera for constantly and smoothly displaying a through image even if recordings are performed successively, and a recording method for this camera.

The camera of the present invention includes an imaging section, a low resolution image generator, a face detector, a still state detector, and a recording section. The imaging section images a subject to obtain an image. The low resolution image generator thins out the image to generate a low resolution image. The face detector detects a face image inside the low resolution image. The still state detector judges that the face image is in a still state when the face image is still for a predetermined time while a release button is half-pressed. The recording section automatically records the low resolution image in a recording device when the still state detector judges that the face image is in the still state.

It is preferable that the still state detector is provided with a still state detection counter for counting the number of frames with the still face image. The still state detector judges that the face image is in the still state when a count of the still state detection counter reaches a predetermined value.

It is preferable that the face detector identifies orientation of the face image of the subject, and the still state detector judges that the face image is in the still state when the orientation of the face image of the subject is continuously in the same or a predetermined specific direction for a predetermined time.

When the release button is fully pressed, it is preferable that the recording section records a high resolution image not thinned out and captured immediately before full-pressing of the release button in the storage device.

It is preferable that the camera further includes a dictionary storage and a selector. The dictionary storage stores multiple kinds of dictionary data in accordance with kinds of the subjects. The selector selects at least one kind of the multiple kinds of the dictionary data. It is preferable that the face detector detects the face image based on the selected dictionary data.

It is preferable that the camera further includes a display section, a display controller, and a touch sensor. The display section displays the low resolution image as a through image. The display controller displays the through image and a face detection frame superimposed on the through image on the display section. The face detection frame surrounds the face image of the subject detected by the face detector. The touch sensor is incorporated in the display section. The touch sensor is used for selecting one of the displayed face detection frames. It is preferable that the still state detector performs the judgment to the face image corresponding to the face detection frame selected using the touch sensor.

It is preferable that the low resolution image is a through image.

The recording method for a camera includes a capturing step, a thinning step, a detecting step, a judging step, and a recording step. In the capturing step, a subject is captured to obtain an image. In a thinning step, the captured image is thinned out to generate a low resolution image. In the detecting step, a face image of the subject is detected inside the low resolution image. In the judging step, the face image is judged to be in a still state when the face image is continuously still for a predetermined time while a release button is half-pressed. In the recording step, the low resolution image is automatically recorded in a recording device when the face image is judged to be in the still state.

In the present invention, the automatic recording is performed when the face image remains still for a predetermined time. Accordingly, the motion blur is surely prevented. Because the automatic recording is performed only when the release button is half-pressed, the automatic recording is surely prevented from being performed at an unintended time. The full-pixel image is thinned out into the low resolution image, and this low resolution image is recorded. Thus, many images can be recorded in the recording medium or device.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a block diagram showing an electric configuration of a camera of the present invention;

FIG. 2 is a block diagram showing an electric configuration of a face detection section;

FIG. 3 is an explanatory view of a display section on which a face detection frame is displayed around a face region;

FIG. 4 is a flowchart showing operation processes of the camera;

FIG. 5 is an explanatory view describing processes for judging whether a face image is still for a predetermined time;

FIG. 6 is a block diagram showing another embodiment in which images are automatically recorded while the face of the subject is oriented in a specific direction for a predetermined time;

FIG. 7 is a flowchart showing another embodiment in which face detection is performed using multiple kinds of dictionary data in accordance with the kind of the subject;

FIG. 8 is a flowchart of an example in which images are automatically recorded while the face of the subject corresponding to a designated face detection frame is still for a predetermined time;

FIG. 9 is a block diagram showing another example of the face detection section;

FIGS. 10A to 10D are explanatory views showing scanning of a subwindow by a partial image generator of FIG. 9;

FIGS. 11A and 11B are explanatory views showing examples of frontal faces and profiles detected by the face detection section of FIG. 9;

FIG. 12 is an explanatory view showing how feature quantities are extracted from partial images using a weak classifier of FIG. 9; and

FIG. 13 is a graph showing an example of a histogram of the weak classifier of FIG. 9.

### DESCRIPTION OF THE PREFERRED EMBODIMENTS

### Embodiment 1

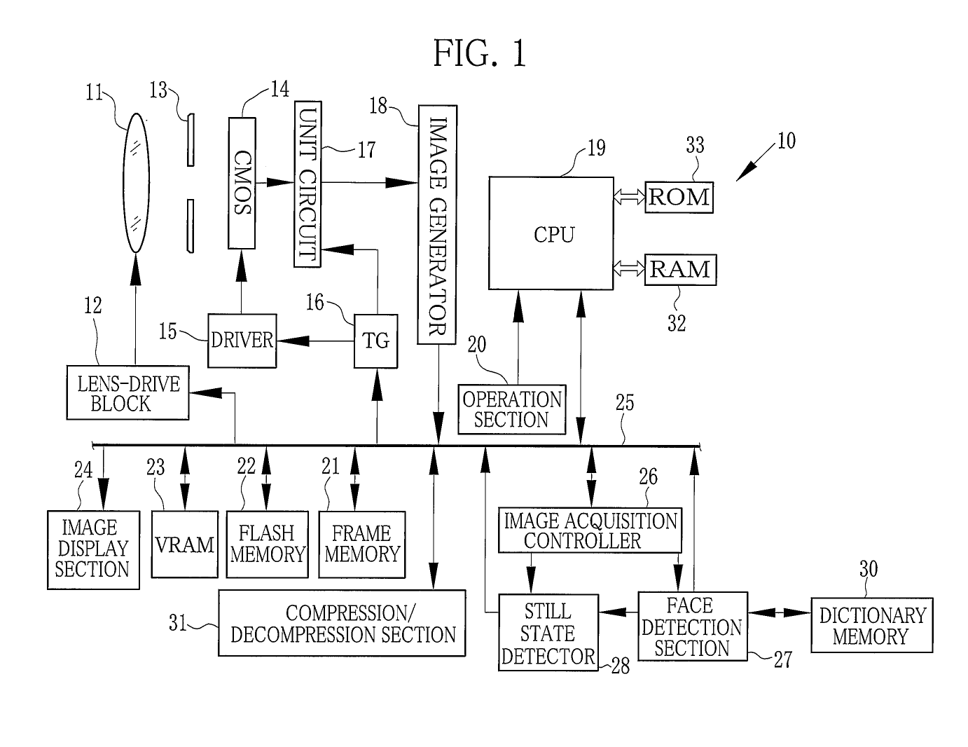

As shown in FIG. 1, an electronic camera 10 of the present invention is provided with a taking lens 11, a lens-drive block 12, an aperture stop 13, a CMOS(Complementary Metal Oxide Semiconductor) 14, a driver 15, a TG (timing generator) 16, a unit circuit 17, an image generator 18, a CPU 19, an operation section 20, a frame memory 21, a flash memory (memory card) 22, a VRAM 23, an image display section 24, a bus 25, an image acquisition controller 26, a face detection section 27, a still state detector 28, a dictionary memory 30, and a compression/decompression section 31. An imaging section is composed of the taking lens 11, the CMOS 14, and the driver 15.

The taking lens 11 is a zoom lens and includes a focus lens (not shown) and a zooming lens (not shown). The lens-drive block 12 is composed of a focus motor (not shown) for driving the focus lens along an optical axis direction, a zoom motor (not shown) for driving the zooming lens along the optical axis direction, a focus motor driver (not shown) for driving the focus motor in accordance with a control signal from the CPU 19, and a zoom motor driver (not shown) for driving the zoom motor in accordance with a control signal from the CPU 19. The lens-drive block 12 controls magnification and focusing of the taking lens 11.

The aperture stop 13 has a driver circuit (not shown) to actuate the aperture stop 13 in accordance with the control signal from the CPU 19. The aperture stop 13 controls an amount of light incident through the taking lens 11.

The CMOS 14 is driven by the driver 15. The CMOS 14 photoelectrically converts each of RGB light from the subject into an image signal (RGB signals) at a constant time interval. The operation timing of each of the driver 15 and the unit circuit 17 is controlled by the CPU 19 via the TG 16.

The TG 16 is connected to the unit circuit 17. The unit circuit 17 is composed of a CDS (Correlated Double Sampling) circuit, an AGC (Automatic Gain Control) circuit, and an A/D converter. The CDS (Correlated Double Sampling) circuit performs correlated double sampling to the image signal outputted from the CMOS 14. After the correlated double sampling, the AGC circuit adjusts gain of the image signal. Thereafter, the A/D converter converts an analog image signal into a digital signal. Thus, the image signal outputted from the CMOS 14 is sent to the image generator 18 via the unit circuit 17 as the digital signal.

The image generator 18 performs image processes such as gamma correction, white-balance processing to the image data sent from the unit circuit 17 to generate a luminance/chrominance signal (YUV data). The generated image data of the luminance/chrominance signal is sent to the frame memory 21.

In the frame memory 21, image data having pixel array information of one frame or one image area is stored in sequence. There are two frame memories 21 for two frames, respectively, for example. When image data of a next frame is inputted during processing of frame image data stored in one of the two frame memories 21, the other frame memory 21 is updated with the next frame image data. Thus, the two frame memories 21 are alternately used.

The CPU 19 has an imaging control function for controlling the CMOS 14, a record processing function for the flash memory 22, and a through image display function, and the CPU 19 controls overall operations of the electronic camera 10. The CPU 19 includes a clock circuit (not shown) and also functions as a timer. Using the through image display function, the CPU 19 thins out frame image data obtained from the image generator 18 to generate frame image data used for displaying a through image (live view image). The CPU 19 sends the generated frame image data for the through image to the image acquisition controller 26 and the VRAM 23. The CPU 19 functions as a low resolution image generator.

The frame image data stored in the VRAM 23 is sent to the image display section 24. The image display section 24 reads the frame image data from the VRAM 23 and converts the frame image data into a signal compliant with a format for the display panel, for example, NTSC format to display a through image on a display section 24a (see FIG. 3). To be more specific, the VRAM 23 has two storage areas into each of which frame image data is written. The two storage areas are alternately used for writing cyclically-outputted frame image data therein. The image data is read from the storage area from which the frame image data is not erased. The through images are displayed on the display section as moving images while the frame image data is constantly erased and rewritten in the VRAM 23. Thus, a through image is displayed on the display section 24a as a moving image.

The operation section 20 includes a release button, a power button, multiple operation keys such as a mode selection key, a cross key, and an enter key. The release button can be half-pressed or fully pressed. Using the mode selection key, modes are selected from among an imaging mode, a replay mode, an initial setting mode, and the like. An operation signal is outputted to the CPU 19 according to the operation of a user.

A RAM 32 and a ROM 33 are connected to the CPU 19. The RAM 32 is used as buffer memory for temporarily storing image data sent to the CPU 19, and also as working memory. Programs for controlling each section during the imaging mode or replay mode are previously stored in the ROM 33.

The compression/decompression section 31 performs compression and decompression processes to the frame image data. The flash memory 22 is a recording medium for storing the frame image data compressed in the compression/decompression section 31. The flash memory 22 is removably attached to the camera body.

The image display section 24 includes the display section 24a such as a color LCD and a drive circuit for the display section. In the imaging mode, the image display section 24 displays thinned-out frame image data (or may referred to as low-resolution frame image data) as a through image. In the replay mode, the image display section 24 displays the frame image data read from the flash memory 22 and decompressed in the compression/decompression section 31.

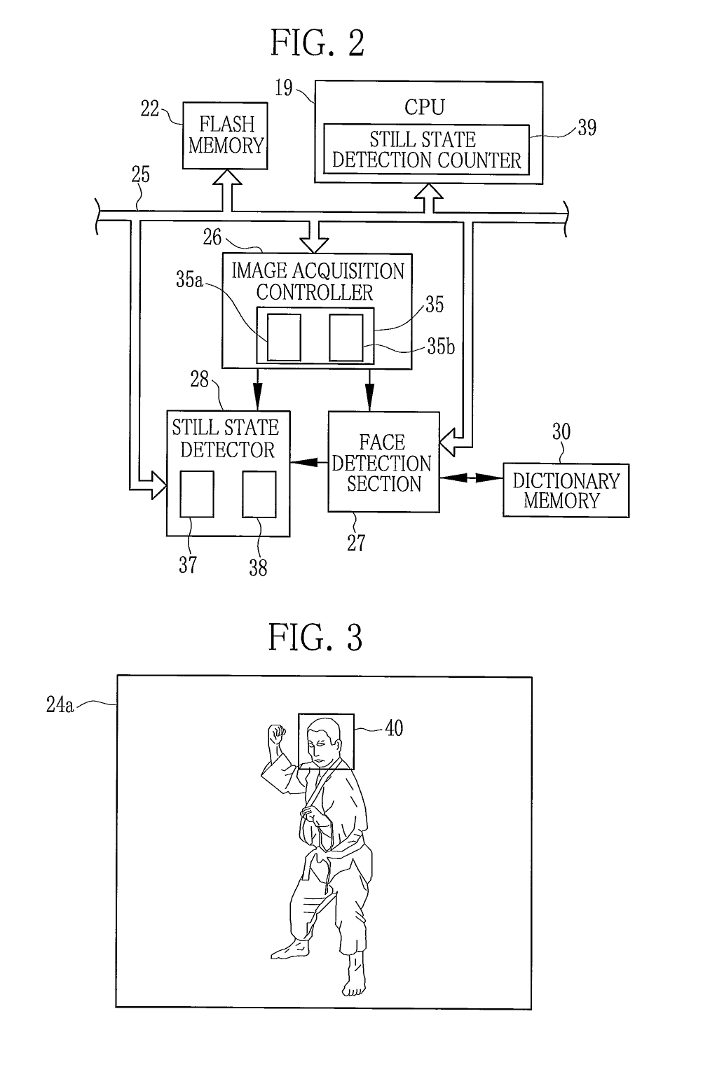

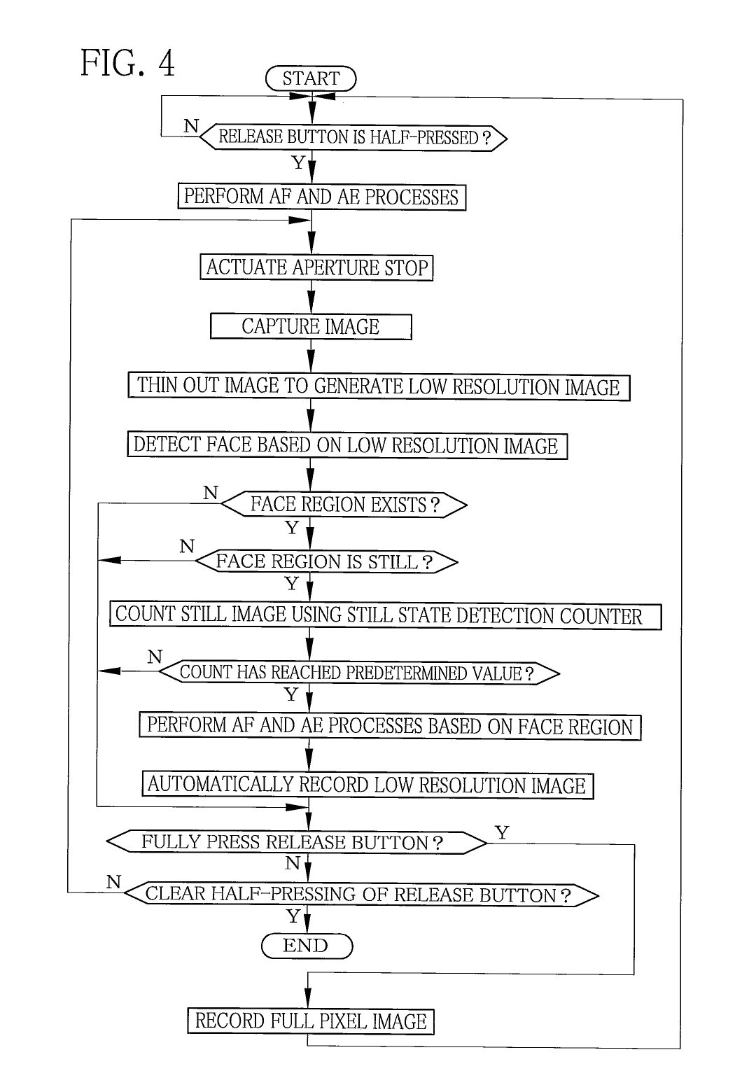

As shown in FIG. 2, the image acquisition controller 26 has a buffer memory 35 for storing the thinned-out frame image data with low resolution. Fully pressing the release button, a full-pixel frame image data is taken into the buffer memory 35 from the frame memory 21. When the release button is not being pressed, the buffer memory 35 obtains from the CPU 19 the frame image data with low resolution used for displaying the through image. The frame image data for the through image in the buffer memory 35 is outputted to the face detection section 27 and the still state detector 28. The buffer memory 35 has two storage areas 35a and 35b as with the VRAM 23.

The dictionary memory 30 is connected to the face detection section 27. The dictionary memory 30 has previously stored feature quantity data of pattern images (reference images). The feature quantity data (reference data) contains information on features of faces of various people in various orientations and includes, for example, feature points such as data of eyes and nostrils.

When the release button is fully pressed, the face detection section 27 may detect a face area in the full-pixel frame image data taken in from the frame memory 21. The face detection section 27 detects a face area relative to the low-resolution frame image data used for the through image.

The face detection section 27 scans a predetermined size of a target area on an image based on the frame image data, obtained from the buffer memory 35, to extract a feature quantity data from the image in the target area. The extracted feature quantity data is compared with each of the feature quantity data stored in the dictionary data 30 to calculate a correlated value (similarity) therebetween. The calculated correlated value and a predetermined threshold value are compared to judge whether a face of the subject exists. Thus a face area is recognized. Then, orientation of the face is identified using the feature quantity data for the orientation identification.

After scanning the entire screen, the face detection section 27 outputs information on the position, the size, and the orientation of the face area of the subject to the CPU 19 and the still state detector 28. As shown in FIG. 3, based on the information from the face detection section 27, the face detection section 27 controls the image display section 24a to display a face detection frame 40, which is a target area for AF and AE processes, superimposed on a through image.

The CPU 19 controls the still state detector 28 to operate only when the release button is half-pressed. The still state detector 28 has two image memories 37 and 38. In the image memory 37, the last frame image data used by the face detection section 27 is stored. In the image memory 38, the present or current frame image data used by the face detection section 27 is stored. The frame image data is outputted sequentially. The frame image data in the image memory 37 and the frame image data in the image memory 38 are erased/rewritten alternately. The last frame image data is stored in one of the image memories 37 and 38 which is not being subjected to erasing/rewriting of the frame image data.

The still state detector 28 obtains from the face detection section 27 information on the position and the size of the face area. The still state detector 28 extracts an image of the face area from each of the last and the current frame image data. Then, the still state detector 28 compares the face areas of the last and the current frame image data. Based on the displacement of the pixels in the face areas, the still state detector 28 judges whether the face of the subject is in a still state or not. When the still state detector 28 judges that the face is still or stationary, the still state detector 28 outputs a stationary signal to the CPU 19. When the still state detector 28 judges that the face is moving, the still state detector 28 outputs a non-stationary signal to the CPU 19.

The CPU 19 has a still state detection counter 39. The still state detection counter 39 activates only during the half-pressing operation of the release button, and counts the number of the stationary signals received successively. When the count of the still state detection counter 39 reaches a predetermined value, the CPU 19 reads the low-resolution frame image data stored in the image memories 37 and 38 of the still state detector 28. The read image data is subjected to compression in the compression/decompression section 31, and then stored in the flash memory 22 or storage device. The CPU 19 changes the color of the face detection frame 40 displayed in the display section 24a in response to the storage of the frame image data in the flash memory 22 to notify the operator that the frame image data is stored during the half-pressing of the release button. When half-pressing of the release button is cleared, the count of the still state detection counter 39 is also cleared. When the release button is half-pressed again, the counting operation resumes after the counter is reset.

An operation of the above configuration is described. When the electric camera 10 is turned on, the CPU 19 makes the CMOS 14 to image the subject at a predetermined frame rate, for example, 30 fps. The image generator 18 obtains the image data captured sequentially with the CMOS 14 and generates the luminance/chrominance signal. The luminance/chrominance signal of the frame image data is stored in the frame memory 21. Upon reading the frame image data from the frame memory 21, the frame image data is thinned out into the low-resolution frame image data. The low-resolution frame image data is sent to the VRAM 23, and then displayed as a through image in the image display section 24.

The low-resolution frame image data is sent to the face detection section 27 via the image acquisition controller 26. The face detection section 27 designates a target area in a first position in the image based on the frame image data. Then, the face detection section 27 compares the feature quantity data extracted from the target area with the feature quantity data stored in the dictionary memory 30. When the face detection section 27 judges that the target area contains no face image, the face detection section 27 moves the rectangular target area to the next position in the image to perform the comparison.

When a face image is extracted in the target area, the face detection section 27 outputs the position information and the size information of the face area to the CPU 19. As shown in FIG. 3, within a range based on the position information and the size information of the face area obtained from the face detection section 27, the CPU 19 superimposes, for example, the blue face detection frame 40 on the through image, and displays the through image and the superimposed face detection frame 40 on the display section 24a. During the display of the through images, AE control and AF control are performed at a predetermined time interval based on the detected face image.

When the release button is half-pressed, the AE and AF processes are performed based on the face image in the face detection frame 40. With the AF process, the focus lens is set in a position where the face image becomes clear. The aperture size of the aperture stop 13 is adjusted to make the brightness of the face image appropriate.

During the half-pressing of the release button, the CPU 19 generates the low-resolution frame image data, and this data is sent to the image acquisition controller 26. The image data is sent to the face detection section 27, and is judged whether a face image exists therein. The detection of the face image is performed to each frame acquired at a predetermined time interval.

During the half-pressing of the release button, the still state detector 28 activates. Based on the position information and the size information of the face area obtained from the face detection section 27, the face image of the current frame image data and the face image of the last-captured frame image data are compared. Whether the face of the subject is in the still state or not is judged based on the displacement of the pixels between the last and current frame image data. When the still state detector 28 judges that the face is still or stationary, the stationary signal is sent to the CPU 19. When the still state detector 28 judges the face is moving, the non-stationary signal is sent to the CPU 19.

When the CPU 19 receives the stationary signal, the still state detection counter 39 counts the number of the stationary signals. The count of the still state detection counter 39 is cleared when the still state detection counter 39 receives the non-stationary signal, when the half-pressing (or the full-pressing) of the release button is cleared, or when the low-resolution image is recorded.

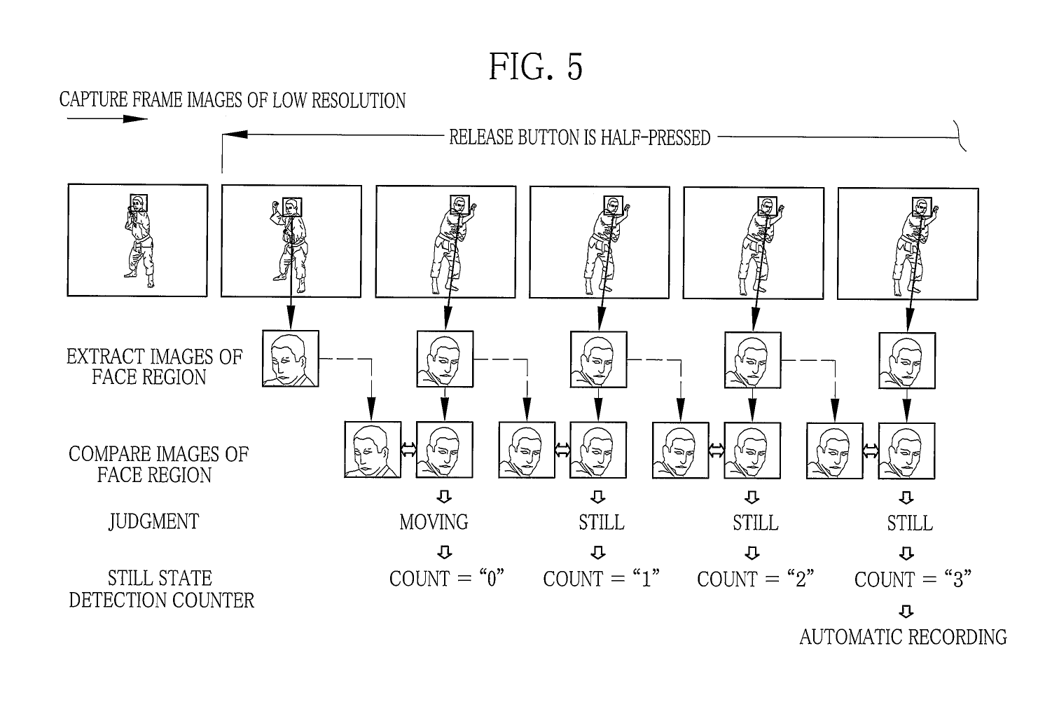

The CPU 19 monitors the count of the still state detection counter 39. When the count reaches the predetermined value, for example, “3”, the CPU 19 compresses the low-resolution frame image data, which has been used by the face detection section 27, and stores it in the flash memory 22 or storage device. As shown in FIG. 5, during the half-pressing of the release button and when three frames with the face judged to be still or stationary are captured successively, the frame image data of the last frame (the third frame) is automatically recorded in the flash memory 22 or storage device. It should be noted that when the count reaches “3”, the low resolution image may be obtained from the captured frame after the AE and AF processes, and this low-resolution image is stored in the flash memory 22.

The still state detection counter 39 counts the number of frames with the face image judged still. Alternatively, the automatic recording may be performed when the face images are still during a predetermined time period after the first frame with the still face is captured.

When the automatic recording is performed, the CPU 19 changes the color of the face detection frame 40, for example, from blue to red in the display section 24a. In order to notify the operator of the automatic recording, it is preferable to sufficiently extend the time for displaying the face detection frame 40 in red.

When the release button is fully pressed, the full-pixel frame image data with high resolution captured and stored in the frame memory 21 immediately before the full-pressing of the release button is read therefrom and is subjected to the compression in the compression/decompression section 31. Then, the frame image data is stored in the flash memory 22 or storage device as the recorded image.

To prevent motion blur, imaging at a high shutter speed is known. However, it is extremely difficult to prevent the subject from moving because the motion of the subject is unpredictable. In the above embodiment, images with the still face are temporarily recorded before the release button is fully pressed. Even if the motion blur is caused in the captured image due to the motion of the subject when the release button is fully pressed, an image with no motion blur is surely recorded before fully pressing the release button. Even if the motion blur is caused in the captured high resolution image, the previously recorded low resolution image may be used as a substitute for the high resolution image.

An imaging technique called panning is known. The panning refers to moving the camera in accordance with a subject in fast motion, for example, a runner in a 100-m race or a driver of a racing car while imaging. In the above embodiment, the advance recording is performed when the face area of the image is still for a predetermined time regardless of the background. Therefore, the images are surely captured without causing the motion blur even if the panning technique is used.

### Embodiment 2

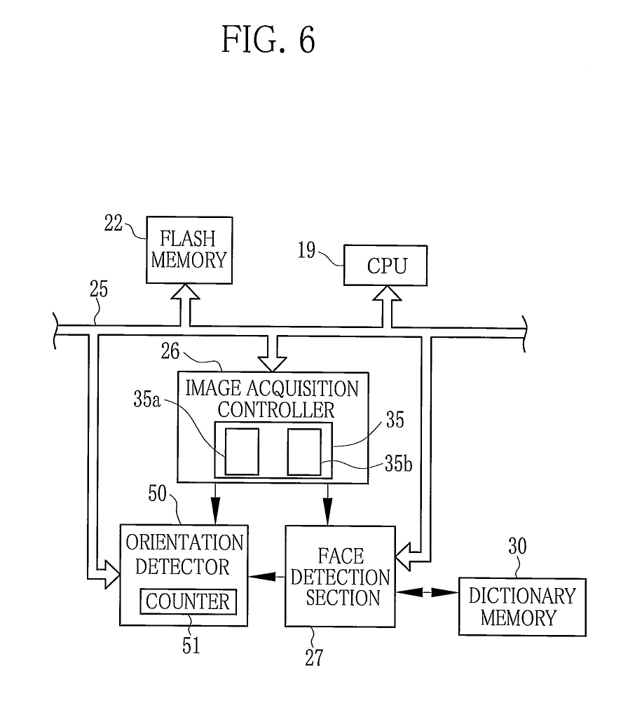

In the above embodiment, for the automatic recording of still images, the still state detector 28 is provided to judge whether the face image of the subject is in a still state or not. In this embodiment, the still state detector 28 is omitted. Alternatively, an orientation detector for detecting an orientation of the subject is provided. As shown in FIG. 6, an orientation detector 50 has a counter 51. The face detection section 27 judges whether the orientation information of the subject is in the specific orientation or the same as the orientation of the previous image. The counter 51 counts the number of the successive judgments of the same or specific orientation. When the count of the counter 51 reaches a predetermined value, in other words, the face of the subject is oriented in the same or specific direction, the low resolution image data is automatically recorded. To judge the orientation of the subject to be in a specific direction, for example, the front direction or the obliquely upward direction may be determined as the specific direction. An orientation selector may be provided to allow the operator to select the orientation. Information of this selected specific direction is stored in the memory.

### Embodiment 3

In this embodiment, for example, dictionary data (reference data) for dogs, cats, flowers, cars, or airplanes may be used to detect an object corresponding to the dictionary data as a subject. In this embodiment, for example, a dog can be captured with no motion blur.

### Embodiment 4

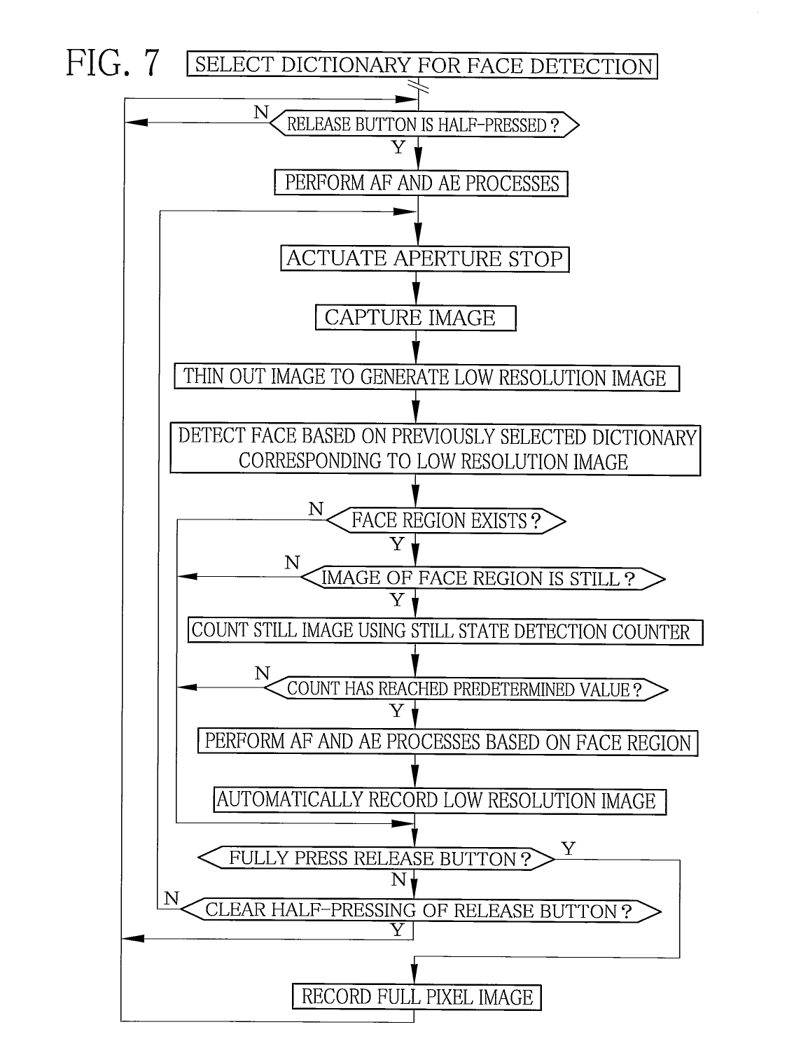

In the case where multiple dictionary data (reference data) is used to correspond to the kinds of the faces, for example, it is preferable that the operator previously selects the dictionary data through initial setting operation and the like. In this case, as shown in FIG. 7, the face of the subject corresponding to the selected dictionary data is detected. The operator performs initial setting operation while looking at a screen on the display section 24a. Operating the mode selection key, the initial setting mode is selected. Operating the cross key, an item “select dictionary data to be used” is designated from among other items in the initial setting screen. Thereby, the names of the kinds of dictionary data stored in the dictionary memory 30 are displayed in the display section 24a. A cursor or a selection frame is moved in a vertical or a horizontal direction onto a desired dictionary data, and then the enter key is operated. Thus, the dictionary data is designated. The designated dictionary data is stored in the memory. The face detection section 27 detects the face image using the designated dictionary data. When the face of the subject of the designated kind is still or stationary during the half-pressing of the release button, the automatic recording is performed. One or multiple kinds of dictionary data may be selected. Kinds of faces include men and women, children and adults, frontal faces and profiles, and their combinations.

### Embodiment 5

When multiple faces are detected, multiple face detection frames 40 are displayed in the image display section 24a. The still state detector 28 performs the detection whether all the face areas are in the still state. The automatic recording may be performed when all the faces of the subjects are still for a predetermined time.

### Embodiment 6

A touch sensor may be provided on the display section 24a. Touching the screen selects one of the displayed face detection frames 40. The still state detector 28 judges whether the subject is in a still state based only on the face inside the selected face detection frame 40. It is difficult for the operator to touch the display section 24a while half-pressing the release button. As shown in FIG. 8, it is preferable to perform the touch-selection prior to the half-pressing operation. When the release button is half-pressed, the face detection is performed with respect to an area corresponding to the face detection frame 40 designated by touching. The automatic recording is performed when the face image of the subject inside the designated face detection frame 40 is still for a predetermined time as with the above. When the face image of the subject is not detected in the area of the designated face detection frame 40 or when the half-pressing of the release button is cleared, the designation of the face detection frame 40 is cleared.

### Embodiment 7

Multiple dictionary data (reference data) may be stored in the dictionary memory 30. The face detection section 27 may detect the kind of face which applies to all the dictionary data. The display section 24a is provided with a touch sensor. One of the displayed face detection frames 40 is selected by touching the display section 24a. The still state detector 28 judges whether the subject is in a still state based on the face image of the subject corresponding to the designated face detection frame 40. The operation is the same as that described in FIG. 8.

### Embodiment 8

A setting of the still state detection counter 39 represents the number of frames or time interval between the detection of the still state and the start of the automatic recording. This setting may be changed in accordance with the kind of the subject. The face detection frame 40 of the subject of the desired kind is designated from among the multiple face detection frames 40 by touching the screen. The CPU 19 identifies the kind of the subject based on the dictionary data which the face detection section 27 uses for the face detection. Then the CPU 19 reads from the ROM 33 the previously stored count value corresponding to the identified kind of the subject, and sets the read value in the still state detection counter 39. The still state detection counter 39 is a down counter. When the still state detection counter 39 is counted down to zero, the still state detector 28 judges that the face of the designated kind of subject is in a still state for a predetermined time and starts the automatic recording. The setting of the still state detection counter 39 may change depending on the kind of the subject. It is preferable to set a short time interval before the still-state judgment when the subject moves fast and a long time interval when the subject moves slow.

In the above embodiments, the low-resolution frame image data used for the through image is automatically recorded. Alternatively or in addition, the full-pixel frame image data captured in the frame memory 21 may be thinned out to generate the low-resolution frame image data, and this low-resolution frame image data may be recorded.

The CMOS 14 is used as the imaging section. Alternatively, a CCD may be used. In the case where the CMOS 14 is used, it is preferable to shut the aperture stop 13 once during the half-pressing of the release button to drain the electrical charge, which resets the CMOS 14.

Known methods such as edge detection, hue detection, and skin tone detection can be used as the face detection method for the face detection section 27 of the above embodiments.

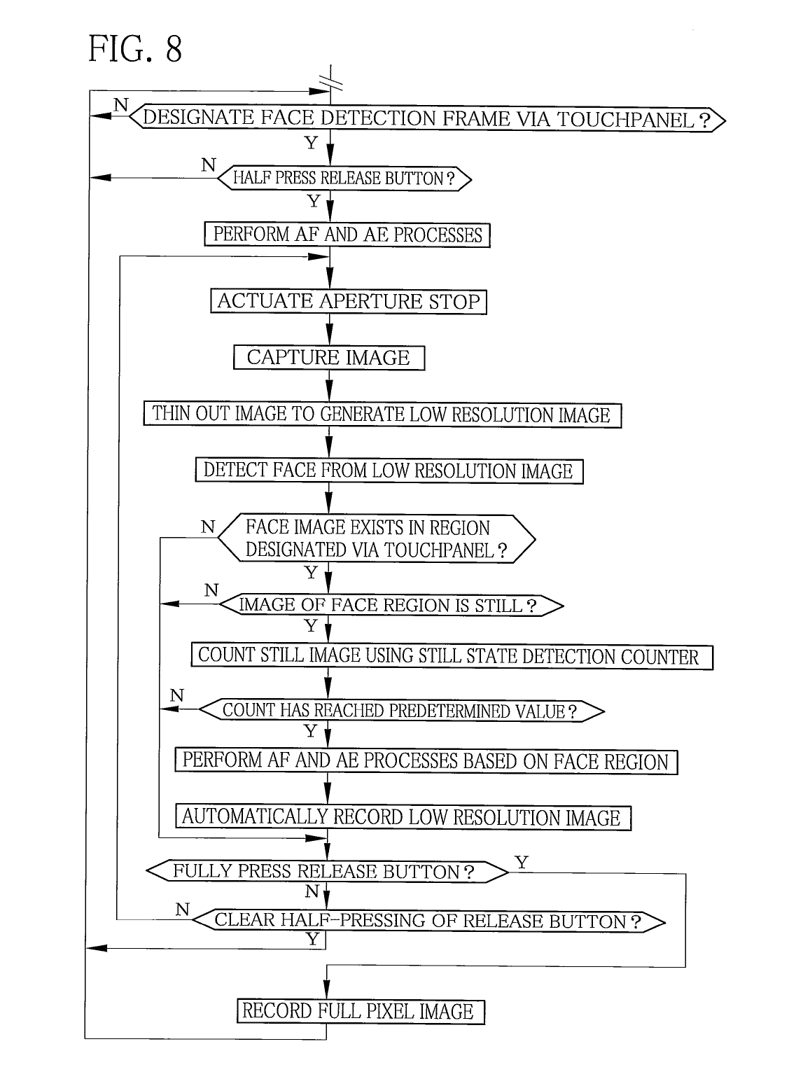

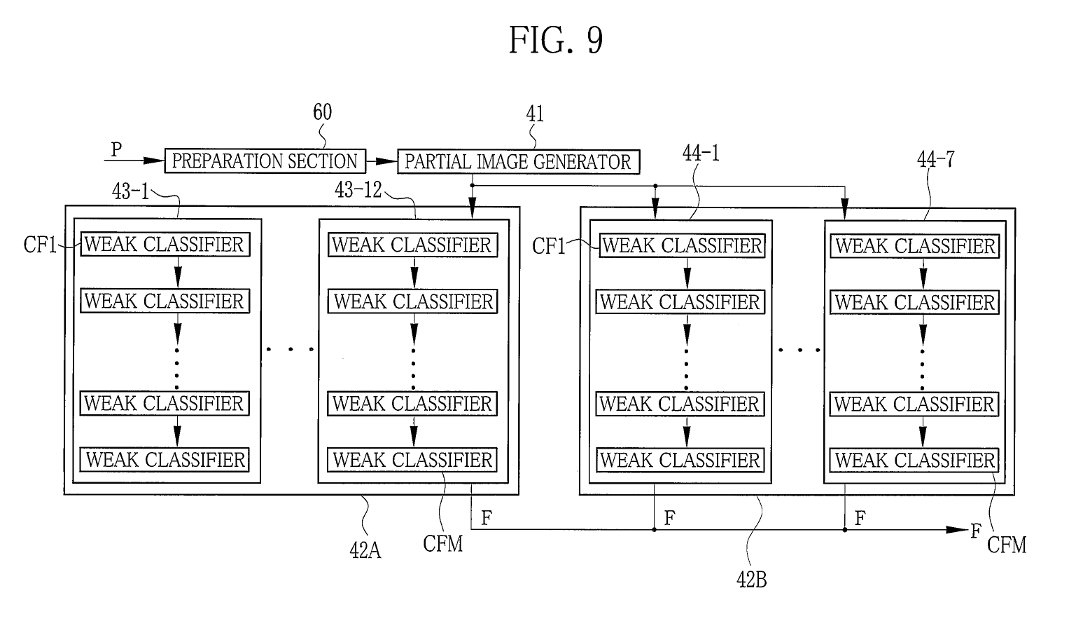

For another example of the face detection section 27, a face may be detected using Adaboosting algorithm. In this case, as shown in FIG. 9, the face detection section 27 has a partial image generator 41, a frontal face detector 42A, and a profile detector 42B. The partial image generator 41 scans a whole image P of the captured frame image data with a subwindow W to generate an image (hereinafter referred to as partial image) PP of the target area. The frontal face detector 42A detects a frontal face (partial image) from among the multiple partial images PP generated by the partial image generator 41. The profile detector 42B detects a profile or face seen from the side (partial image).

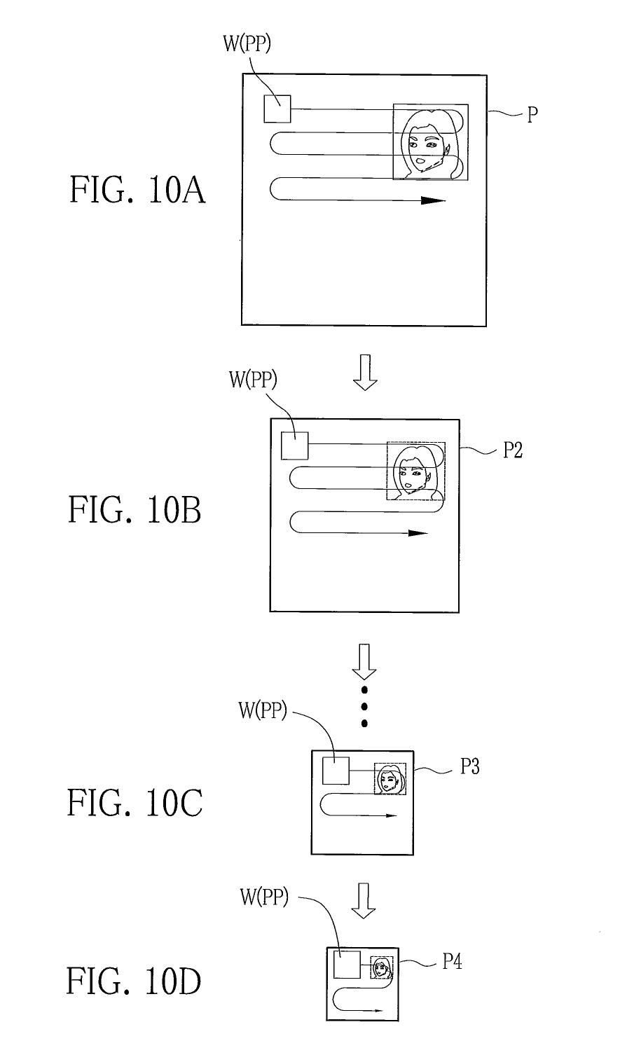

The whole image P inputted to the partial image generator 41 has been subjected to preparation process or pretreatment (pre-processing) in a preparation section 60. As shown in FIGS. 10A to 10D, the preparation section 60 has a function to decompose the whole image P into multi-resolutions to generate whole images P2, P3, and P4 which differ in resolution. The preparation section 60 has a function to perform normalization (hereinafter may referred to as local normalization). The local normalization is to suppress variations of contrast in local areas in the generated multiple whole images P to normalize or smooth out the contrast to a predetermined level over the entire area of the whole image P.

As shown in FIG. 10A, the partial image generator 41 scans the image P with a subwindow W having a predetermined number of pixels (for example, 32×32 pixels) to cut out an area inside the subwindow W. Thereby, a partial image PP having a predetermined number of pixels is generated. Specifically, the partial image generator 41 skips a predetermined number of pixels during the scanning with the subwindow W to generate the partial image PP.

As shown in FIGS. 10B to 10D, the partial image generator 41 also scans the low resolution image with the subwindow W to generate the partial image PP. Even if a face is not contained or extends off the subwindow W in the whole image P, it becomes possible to locate the face inside the subwindow W in the low resolution image. Thus, the face detection is surely performed.

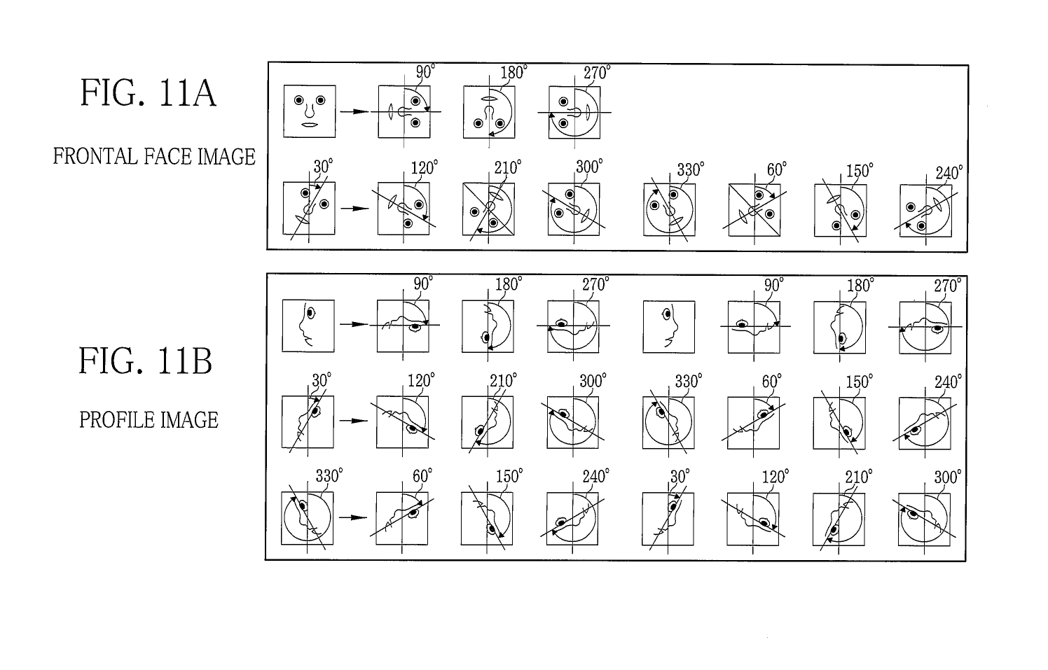

The frontal face detector 42A and the profile detector 42B detect a face image F using Adaboosting Algorithm. The frontal face detector 42A has a function to detect a frontal face rotated at various in-plane rotation angles (see FIG. 11A). The frontal face detector 42A has 12 frontal face classifiers 43-1 to 43-12 which differ in the rotation angle by 30° (degrees) from each other from 30° to 330°. Each of the frontal face classifiers 43-1 to 43-12 is capable of detecting a face at an angle in a range from) −15° (=345°) to +15°, 0° being at the center. The profile detector 42B has a function to detect a profile rotated at various in-plane rotation angles (see FIG. 11B). The profile detector 42B is provided with, for example, seven profile classifiers 44-1 to 44-7 which differ in the rotation angle by 30° (degrees) from each other from −90° to +90°. The profile detector 42B may be provided with a profile classifier which detects an image with orientation at an out-of-plane rotation angle.

Each of the frontal face classifiers 43-1 to 43-12, and the profile classifiers 44-1 to 44-7 has a function to perform binary classification whether the partial image PP is a face or a non-face, and is provided with multiple weak classifiers CF1 to CFM (M: the number of weak classifiers). Each of the weak classifiers CF1 to CFM extracts a feature quantity x from the partial image PP to classify whether the partial image PP is a face or non-face. Each of the frontal face detector 42A and the profile detector 42B uses the classification results of the weak classifiers CF1 to CFM to ultimately classify the face and non-face.

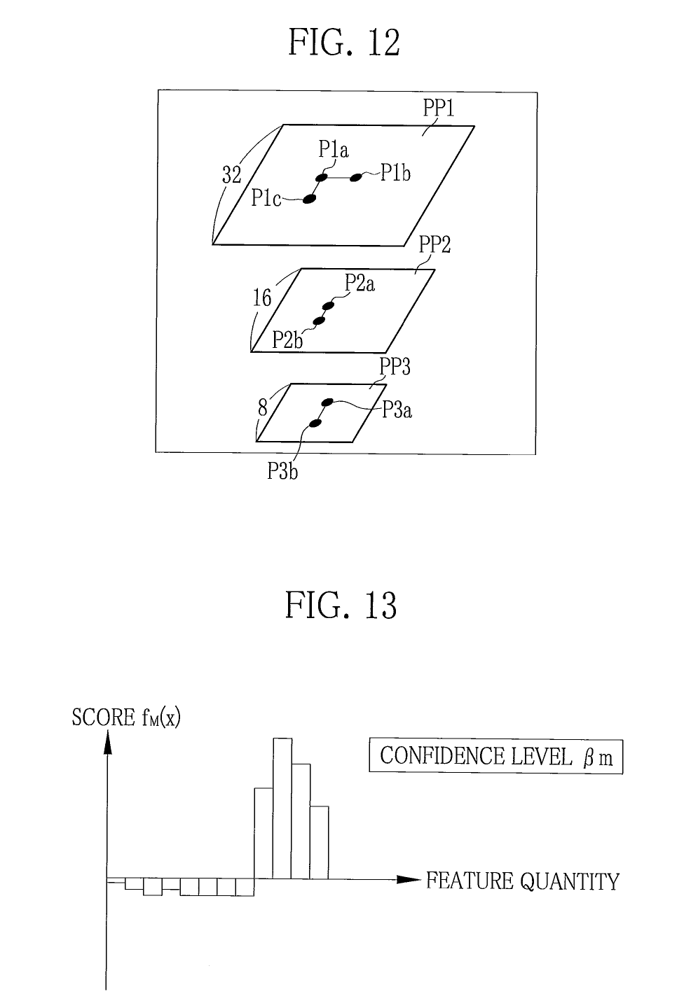

To be more specific, as shown in FIG. 12, each of the weak classifiers CF1 to CFM extracts brightness or the like at coordinates P1a, P1b, and P1c in the partial image PP, and at coordinates P2a, P2b in the low resolution partial image PP2, and at coordinates P3a, P3b in the low resolution partial image PP3. Thereafter, two of the above described seven coordinates P1a to P3b are paired off. The brightness difference between the paired coordinates is defined as a feature quantity x. Each of the weak classifiers CF1 to CFM uses a different feature quantity x. For example, the weak classifier CF1 uses the brightness difference between the coordinates P1a and P1c as the feature quantity x. The weak classifier CF2 uses the brightness difference between the coordinates P2a and P2c as the feature quantity x.

In the above example, each of the weak classifiers CF1 to CFM extracts the feature quantity x. Alternatively, the feature quantity may be extracted in advance relative to multiple partial images PP. This feature quantity x may be inputted to each of the weak classifiers CF1 to CFM. In the above example, brightness is used as the feature quantity x. Alternatively, information on contrast, edge, or the like may be used as the feature quantity x.

Each of the weak classifiers CF1 to CFM has a histogram shown in FIG. 13. The weak classifiers CF1 to CFM output scores f1(x) to fM(x) based on the histograms, respectively. Each of the scores f1(x) to fM(x) corresponds to the feature quantity x. Each of the weak classifiers CF1 to CFM is provided with a confidence level β1˜βM indicating classification performance. The weak classifiers CF1 to CFM calculate classification scores βm·fm(x) using the scores f1(x) to fM(x) and confidence levels β1 to βm. Each classifier CFm recognizes the partial image PP as a face when the classification score βm·fm(x) is above a threshold value Sref (βm·fm(x)≧Sref).

Each of the weak classifiers CF1 to CFM has a cascade structure. The partial image PP is outputted as the face image F only when all the weak classifiers CF1 to CFM classify the partial image PP as the face. To be more specific, only the partial image PP classified as the face by the weak classifier CFm is subjected to the next classification by the weak classifier CFm+1 downstream from the weak classifier CFm. If the partial image PP is classified non-face by the weak classifier CFm, no further classification by the weak classifier CFm+1 is performed. Thereby, an amount of partial image PP to be classified decreases at the downstream weak classifiers. As a result, classification operation becomes faster. The classifier having a cascade structure is detailed in “Fast Omni-Directional Face Detection” Shihong LAO, et al., Meeting on Image Recognition and Understanding (MIRU2004), July, 2004.

Each of the frontal face classifiers 43-1 to 43-12 and the profile classifiers 44-1 to 44-7 has weak classifiers which has learned the frontal face or the profile rotated at an in-plane rotation angle as a correct sample image. Instead of individually classifying whether each of the classification scores S1 to SM (outputted from the corresponding weak classifier from CF1 to CFM) is equal to or larger than the classification-score threshold value Sref, the classification at the weak classifier CFm may be performed based on whether the sum Σr=1mβr·fr of the classification scores of the weak classifiers CF1 to CFm−1 upstream from the weak classifier CFm is equal to or larger than the classification score threshold value S1ref(Σr=1mβr·fr(x)≧S1ref). Thereby, the classification can be performed in consideration of the classification scores of the weak classifiers located in the upstream side. As a result, the classification accuracy is improved.

For the face detection, the face detection section 27 may use known face detection algorithm such as SVM (Support Vector Machine) algorithm and a face detection method disclosed in Ming-Hsuan Yang, David J. Kriegman, Narendra Ahuja: “Detecting faces in images: a survey”, IEEE transactions on Pattern Analysis and Machine Intelligence, vol. 24, No. 1, pp. 34-58, 2002.

As described above, the face detection section 27 has a partial image generator and a face classifier having multiple weak classifiers, for example. The partial image generator scans the captured image with a subwindow having a frame of a predetermined number of pixels to generate multiple partial images. The face classifier detects a partial image (face) from among the generated partial images. Using multiple classification results of the weak classifiers, the face classifier classifies whether the partial image is a frontal face or a profile rotated at a predetermined in-plane rotation angle. In this case, the still state detector judges that the face is in a still state when the face image of the subject is a frontal face or a profile of constant orientation at a predetermined in-plane rotation angle for a predetermined time.

Various changes and modifications are possible in the present invention and may be understood to be within the present invention.

What is claimed is:

1. A camera comprising:
an imaging section for imaging a subject to obtain an image;
a low resolution image generator for thinning out the image to generate a low resolution image;
a face detector for detecting a face image inside the low resolution image;
a still state detector for judging that the face image is in a still state when the face image is still for a predetermined time while a release button is half-pressed; and
a recording section for automatically recording the low resolution image in a storage device when the still state detector judges that the face image is in the still state.

2. The camera of claim 1, wherein the still state detector is provided with a still state detection counter for counting the number of frames with the still face image, and the still state detector judges that the face image is in the still state when a count of the still state detection counter reaches a predetermined value.

3. The camera of claim 1, wherein the face detector identifies orientation of the face image of the subject, and the still state detector judges that the face image is in the still state when the orientation of the face image of the subject is continuously in the same or a predetermined specific direction for a predetermined time.

4. The camera of claim 1, wherein when the release button is fully pressed, the recording section records a high resolution image not thinned out and captured immediately before full-pressing of the release button in the storage device.

5. The camera of claim 1, further comprising:
a dictionary storage for storing multiple kinds of dictionary data in accordance with kinds of the subjects; and
a selector for selecting at least one kind of the multiple kinds of the dictionary data;
wherein the face detector detects the face image based on the selected dictionary data.

6. The camera of claim 1, further comprising:
a display section for displaying the low resolution image as a through image;
a display controller for displaying the through image and a face detection frame superimposed on the through image on the display section, the face detection frame surrounding the face image of the subject detected by the face detector; and
a touch sensor incorporated in the display section, the touch sensor being used for selecting one of the displayed face detection frames;
wherein the still state detector performs the judgment to the face image corresponding to the face detection frame selected using the touch sensor.

7. The camera of claim 1, wherein the low resolution image is a through image.

8. A recording method for a camera comprising the steps of:
capturing a subject to obtain an image;
thinning out the captured image to generate a low resolution image;
detecting a face image of the subject inside the low resolution image;
judging that the face image is in a still state when the face image is continuously still for a predetermined time while a release button is half-pressed; and
automatically recording the low resolution image in a recording device when the face image is judged to be in the still state.
